(19) United States
(12) Patent Application Publication
(10) Pub. No.: US 2020/0000291 A1
(43) Pub. Date: Jan. 2, 2020

(54) DISPENSER

(71) Applicant: Conopco, Inc., d/b/a UNILEVER, Englewood Cliffs, NJ (US)

(72) Inventors: Srinivasan KRISHNAN, New Canaan, CT (US); James Chi Wai LO, Yuen Long (HK); Yong PAN, Guangzhou City (CN)

(73) Assignee: Conopco, Inc., d/b/a UNILEVER, Englewood Cliffs, NJ (US)

(21) Appl. No.: 16/473,459

(22) PCT Filed: Dec. 13, 2017
(86) PCT No.: PCT/EP2017/082672

§ 371 Date: Jun. 25, 2019

(30) Foreign Application Priority Data
Dec. 29, 2016 (CN) PCT/CN2016/112897

(51) Int. Cl. A47K 5/14; F16J 15/02

(52) U.S. Cl. CPC A47K 5/14; F16J 15/022

(57) ABSTRACT

A connecting system comprising a hollow transfer tube having at least two openings and one or more walls defining an aperture sealed at one end with a polymeric seal, the aperture being large enough to accommodate the transfer tube. The invention is also directed to a refill cartridge and to a dispenser. The dispenser includes a housing having an opening suitable for accommodating the refill cartridge. The housing includes at least one of i) one or more walls defining an aperture sealed at one end with a polymeric seal, the aperture being large enough to accommodate a transfer tube, the opening being in fluid communication with a conduit within the housing or ii) a hollow transfer tube, having at least two openings, extending from the housing, one opening being in communication with a conduit in the housing and the second opening in fluid communication with the exterior of the dispenser housing. The dispenser may include a u-shaped vent tube and a double valve liquid pump.

### BACKGROUND OF THE INVENTION

Much attention has been directed to the importance of hygiene in prevention of disease. Washrooms have been identified as a significant source of germs since people tend to handle various surfaces, including soap dispensers, and as a result obtain and spread the microorganisms.

Devices which provide touchless dispensing of soaps and other washing liquids have been developed to help minimize human contact with bathroom surfaces during washing. Typically, the devices comprise a container for the soap or other washing liquid, a means for detecting the presence of the person's hands, and an apparatus for pumping the washing material from the soap container to the hands. Some devices provide for combining the washing liquid with air in order to dispense the washing material as a foam. In many dispensers, upon depletion the soap container can be removed from the housing and replaced with a new, filled one.

In addition to the enhanced sensory aspects of a foam, washing compositions in the form of a foam are advantageous in that less liquid formula is required to obtain the same or better lathering capabilities, which in turn means less ingredient usage and potentially less packaging material. Thus, it is desirable that a dispenser of washing liquids be capable of dispensing as foam and also have other features which conserve the washing liquid.

Since the soap containers will often be removed and replaced multiple times in the life of the dispenser, a challenge in the development of these devices resides in providing a connection between the dispenser housing and the soap container which will reliably permit transfer and free flow of the washing liquid from the removable soap container to a conduit in the housing for ultimate dispensing through a nozzle. In addition, in many devices, there is a need to pass air from and/or to the soap container. Any exchange of liquid or air between the soap container and the housing needs to be with no or minimal leaks, which could result in undesirable loss of washing product and possible interference with other aspects of the apparatus.

Wong et al. U.S. Pat. No. 8,348,105 discloses a foam dispensing device. A motor powers a liquid pump and an air pump. The liquid pump transports liquid from a removable liquid storage unit to a mixing chamber, and the air pump propels air through the mixing chamber wherein the air becomes pressurized. The liquid air mixture is propelled through a unit of porous material creating a foam, which is dispensed through an outlet. The liquid storage unit is releasably engageable with a receiving unit which has an outer wall and hollow “piercers.” The liquid storage unit includes two diaphragms which are impermeable to air and liquid prior to engagement with the receiving unit. The diaphragms seal the container prior to insertion of the container into the receiving unit. When the container engages with the receiving unit, the “piercers” are said to puncture the diaphragm and create a vent aperture and a liquid outlet. Use of the diaphragms and the hollow “piercers” are said to prevent leakage. Although the “piercers” are said to puncture the diaphragms, the figure (FIG. 1) seems to show the piercers lifting the diaphragm instead.

CN202654024 discloses an automatic induction liquid outlet bottle having a drill bit connected with a driving device.

CN203914723U discloses an automatic infrared induction bubble blowing hand sanitizer machine. The machine features a main machine body and a liquid storage bottle containing hand sanitizer. A liquid and air mixing device, an infrared induction device, a suction device, a micro motor and a printed circuit board are arranged in the main machine body. A liquid outlet structure comprises a fixed base for fixing the liquid storage bottle, an ejector pin liquid outlet valve arranged in the fixed base and a clamping ring for clamping a bottle mouth of the liquid storage bottle.

CN203914725U discloses a double-pump bubble blowing infrared induction hand sanitizer machine and a liquid storage bottle. A main machine body includes a liquid and air mixing device, an infrared induction device, a liquid compression pump, an air compression pump, a motor and a printed circuit board.

Celest U.S. Pat. No. 4,967,935 discloses a self-venting pump.

Leonard et al. U.S. Pat. No. 6,505,356 discloses in FIGS. 19(a) and 19(c) a reservoir bottle 43 provided with a venting aperture 44 distinct from the mouth 45 of the reservoir bottle. Both the venting aperture and the mouth of the reservoir bottle of Leonard et al. are sealed with a breakable seal (col. 10, line 57). Hollow post 47 breaks the seal and is inserted into the venting aperture 44 to seal the aperture. A. venting channel is provided along the bore of hollow post 47. The act of inserting the inverted reservoir bottle into the housing causes the cap used to seal the reservoir bottle to break.

NL 6410289A disclose pierceable rubber members punctured by hollow needles in a transfusion bag,

WO 94/15516 discloses a dispenser device for liquid detergent product. The housing is is provided with a hollow needle which is situated such that a membrane of a container is pierced by the hollow needle when the container is fixed into the housing. A tight, non-leaking fixation is said to be important to prevent spillage and skin contact with the detergent product.

Meyer U.S. Pat. No. 5,544,788 discloses a dispenser for soap lather. When the bellows expands or contracts, they can draw air into or along the outlet of the lather generator.

Azuma et al. U.S. Pat. No. 5,540,362 discloses a liquid soap supplying device and appears to show a sink with a u-shaped pipe.

Tinker U.S. Pat. No. 6,386,390 discloses a tubular member which is designed to inhibit or prevent the dripping of soap from a dispenser.

U.S. Pat. No. 8,087,543 discloses a lid which can include an air vent so as to allow air to enter a dispenser reservoir as the level of liquid soap falls within the reservoir.

Corney U.S. Pat. No. 9,072,411 discloses air vented liquid dispensers including refill units. A manifold secured to the neck portion underneath the container includes an air passage for air to enter into the container and a liquid passage for air to exit the container. A gasket member is located between the container neck and the manifold and has a flexible and resilient flap portion which acts as a check valve for the air passage. An air tube carries the air up into the rigid container.

Maddox et al. U.S. Pat. No. 6,216,916 discloses a pump for dispensing fluids from a dispenser. The pump includes a flexible dome. The pump also includes valves for selectively opening and closing the pump to fluid communication.

Other pump and/or valve arrangements are shown in U.S. Pat. No. 8,757,454, Ophardt U.S. Pat. No. 7,708,166, CN103976671, Li et al. U.S. Pat. No. 8,955,719, Feriani et al. U.S. Pat. No. 9,095,671, Liang et al. U.S. Pat. No. 8,939,325 and Dong U.S. Pat. No. 8,757,454.

CN203693443U discloses a liquid dispenser having a vent channel independent of a liquid passage.

Smith et al. US 2015/0259188 discloses a venting system.

Quinlan WO 2011/133833 discloses a foam dispenser with a vent valve.

Ophardt et al. U.S. Pat. No. 5,836,482 discloses a device for controlled automatic dispensing of fluids. A removable unit is adapted to be removably coupled to a motor to drive the pump.

Beattie WO2015/019082 discloses a liquid soap dispensing apparatus having an air venting means locatable above the discharge means.

Neo WO2013/082663 discloses a foam soap dispensing unit. An inverted u-shaped conduit is illustrated.

Banks WO01/85356 discloses a squeeze operated foam dispenser. It has an air tube extending from the nozzle cover to an interior portion of air formed between the liquid and the bottle.

### SUMMARY OF THE INVENTION

In a first embodiment, the invention is directed to a connecting system and to dispensers and cartridges utilizing, or adapted to, the new connecting system. The connecting system includes a hollow transfer tube having at least two openings for transferring fluids from one place to another through the connector. The transfer tube may be a needle and has an opening at a first end and a sharp point at the other end, with a second opening positioned at a location spaced from the first opening. Typically, the second opening will be proximate the sharp end. Preferably the transfer tube is comprised of metal.

In use, the transfer tube is accommodated within and penetrates a sealed aperture defined by one or more walls. Typically the aperture leads to a passageway or conduit which accommodates some or all of the length of the transfer tube. When used in a dispenser, generally the transfer tube will be connected to a dispenser housing and the aperture will be associated with the refill cartridge, although the transfer tube may instead be on the cartridge and the aperture wall associated with the dispenser housing.

The aperture is sealed at its outer end with a polymeric sealant to prevent leakage. The aperture is large enough to accommodate the diameter of the transfer tube and the passageway accommodates all or part of the length of the transfer tube. Particularly when used to connect fluids in dispenser housings and refill cartridges, the connecting system affords a reliable communication of fluids between structures with minimal or no leaking of product.

The aperture which receives the hollow tube will typically be cylindrical, although other shaped cross sections such as square or rectangular may be used as appropriate. Similarly, the transfer tube may have a cylindrical or other cross sectional shape.

It has been found that an excellent seal can be obtained from a thermoset elastomer such as liquid silicone rubber (LSR). It is expected, however, that other seals, such as other elastomers, especially thermoset elastomers, may be used. Examples of suitable sealants are silicone rubber and rubber. Various grades will be suitable, as will be known by one of ordinary skill. The material should self-seal after being pierced. Preferably the seal forms an air-tight, septum seal. Thermoplastic elastomers may also be used as sealant, such as Nalgene™ Autoclavable Septum Closure, Autoclavable, 38-430 size available from ThermoFisher Scientific of Waltham, Mass.

The transfer tube is hollow to permit transfer of fluid through it. The first end of the transfer tube is open at a first tube end and typically communicates with a tube or other conduit for passage of the fluid within a dispenser. Spaced from the first end of the transfer tube are one or more second openings. When transporting liquids, the fluid enters the second opening(s) of the transfer tube from the passageway of the aperture. Generally the walls of the passageway lead directly or indirectly to the interior of the refill cartridge. The seal at the outer end of the passageway prevents or impedes escape of the fluid from the aperture/passageway except through the transfer tube. The second transfer tube opening can be provided at various locations, but especially preferred is an opening in the side of the transfer tube. The second transfer tube opening may be any of a variety of shapes, including, for example, oval, oblong, rectangle, circular etc

A portion of the second, sharp tube penetrating end can comprise a beveled or flat wall, preferably the wall which accommodates the second tube opening.

The one or more transfer tubes may extend from a dispenser housing whereby to be available to penetrate a sealed aperture in a refillable soap cartridge. In this case, the walls of the sealed aperture will communicate, directly or indirectly, with the interior of the refill cartridge. The first, open end of the transfer tube is in fluid communication with a conduit within the dispenser, or in the case of a transfer tube used to transfer air, directly or indirectly with the exterior of the dispenser. Where a transfer tube is used to transfer air, the air may travel either through the transfer tube and into the cartridge or from the cartridge through the transfer tube and into the dispenser.

When the cartridge is inserted into the dispenser, the transfer tube penetrates the seal used to seal the opening in the outer end of the aperture walls distal to the cartridge. At least a portion of the transfer tube will be received within the aperture/passageway. This permits fluid to transfer out of the refill cartridge through the passageway to the spaced second transfer tube opening and then through the transfer tube, out the first transfer tube opening and into the dispenser. Again, when the fluid is air, transfer can be either out of the cartridge, through the aperture/passageway and then to the transfer tube and the dispenser, or instead from the dispenser through the transfer tube to the aperture/passageway and thus to the cartridge.

In accordance with a further aspect of the invention, a liquid pump includes both intake and outlet umbrella valves, which helps assure that liquid flows cleanly through the liquid pump without backing up or leaking. Use of the umbrella valves is believed favorably to influence the output pressure and flow profile of the liquid from the pump.

In accordance with another embodiment, a vent opening permits fluid communication between the interior of the cartridge e.g., at an upper end and the exterior of the cartridge whereby to permit venting of air into and out of the cartridge. A venting pipe may be used to permit flow of air to an upper end of the cartridge.

In accordance with yet another embodiment, a u-shaped conduit is used for passage of air from the sealed aperture of the connector to the exterior of the cartridge for venting to minimize or prevent any leakage of cartridge liquid through the venting conduit and out of the dispenser.

For a more complete understanding of the above and other features and advantages of the invention, reference should be made to the following detailed description of preferred embodiments and to the accompanying drawings.

### BRIEF DESCRIPTION OF THE DRAWINGS

FIG. 1 is a perspective view of a dispenser according to the invention.

FIG. 2 is a perspective view of the dispenser of FIG. 1 wherein the refill cartridge has been removed.

FIG. 3 is a perspective view of a refill cartridge comprising a cartridge container and a cartridge cap according to the invention.

FIG. 4 is a bottom perspective view the refill cartridge cap.

FIG. 5 is a rear perspective view of the dispenser of FIG. 1 with the refill cartridge removed to show internal components of the connector.

FIG. 6 is a perspective view of a hollow transfer tube used in accordance with the invention.

FIG. 7 is a top perspective view of the cap of the refill cartridge, showing its interior.

FIG. 8 is a perspective view of the refill cartridge without its cap i.e., the refill container.

FIG. 9 is a perspective view from the rear of the dispenser of the invention with the soap cartridge and portions of the housing omitted.

FIG. 9A is a perspective view from the front and above of the cartridge cap.

FIG. 10 is a perspective view from above of the motor and the pump of the dispenser.

FIG. 11 is a perspective view from the side of the dispenser of the invention with portions of the housing omitted.

FIG. 11A is a perspective view of the exterior of the mixing chamber of the dispenser.

FIG. 12 is an elevation similar to of FIG. 1 but with portions of the dispenser housing removed.

FIG. 13 is a rear perspective view similar to FIG. 5 but with the refill cartridge container present and the cap of the cartridge and other parts omitted.

FIG. 14 is a schematic cross section of the liquid pump of the dispenser.

FIG. 15 is a perspective view from the bottom front of the cartridge cap and plan views of the cover and sealing discs for the connector.

FIG. 16 is a perspective view from above and the right of the cover shown in FIG. 15.

FIG. 17 is a cross section through the cartridge cap.

FIG. 18 is a cross section through the cartridge cap at a point lateral to the section of FIG. 17.

### DETAILED DESCRIPTION OF THE INVENTION

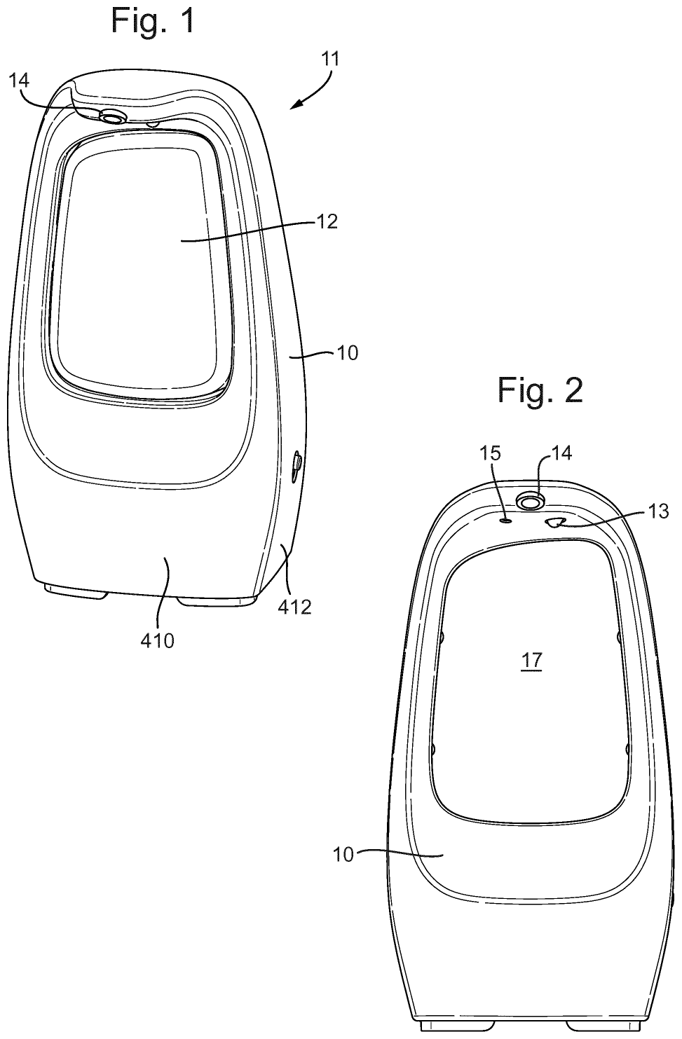

As seen in FIG. 1, dispenser 11 comprises housing 10 and refill cartridge 12. The housing comprises a front housing cover, 410 and a housing body 412 fastened together with screws and screw plugs (not shown). Nozzle 14 at an upper end preferably ejects foam comprising air and soap or other washing fluid when a signal emitted from emitter 13 (FIG. 2) is reflected by a human hand and received by receiver 15. The cartridge is readily removable by the user as can be seen in FIG. 2 wherein removal of the cartridge has left opening 17 in housing 10. The cartridge can then be replaced if it has been removed because it is depleted.

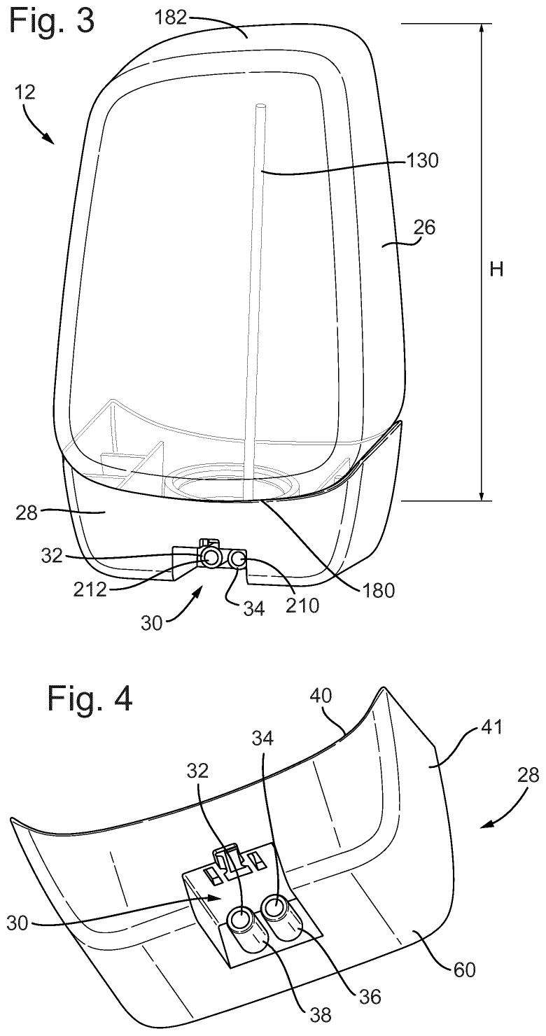

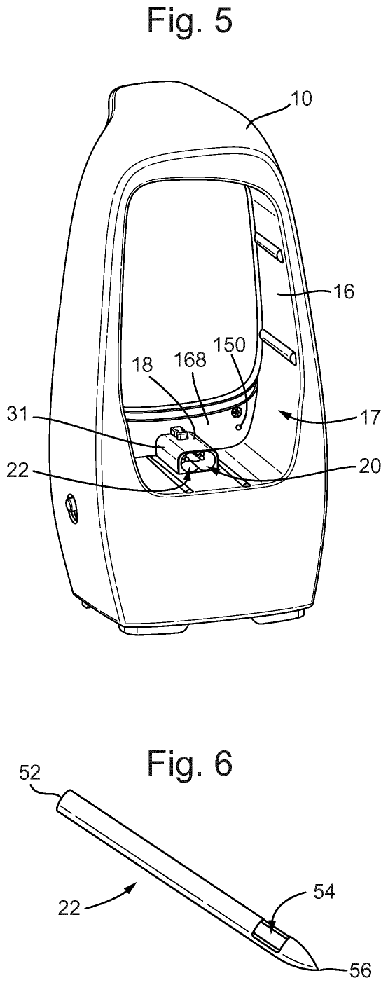

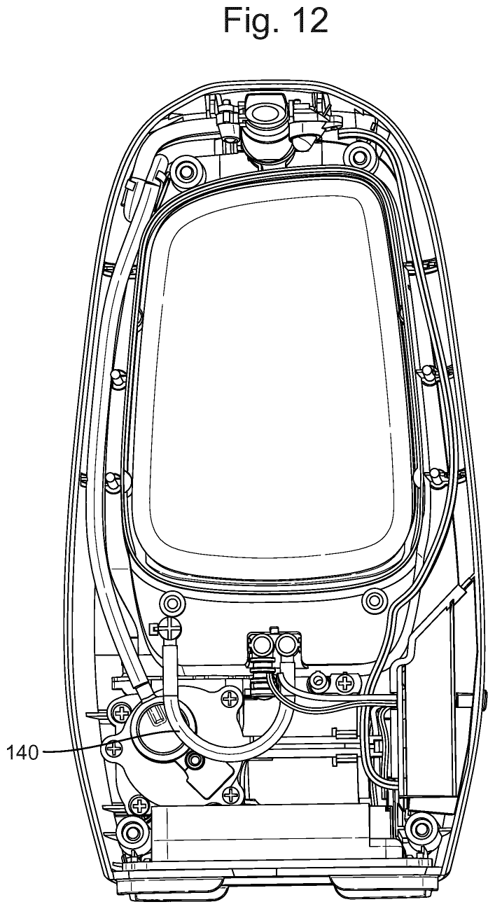

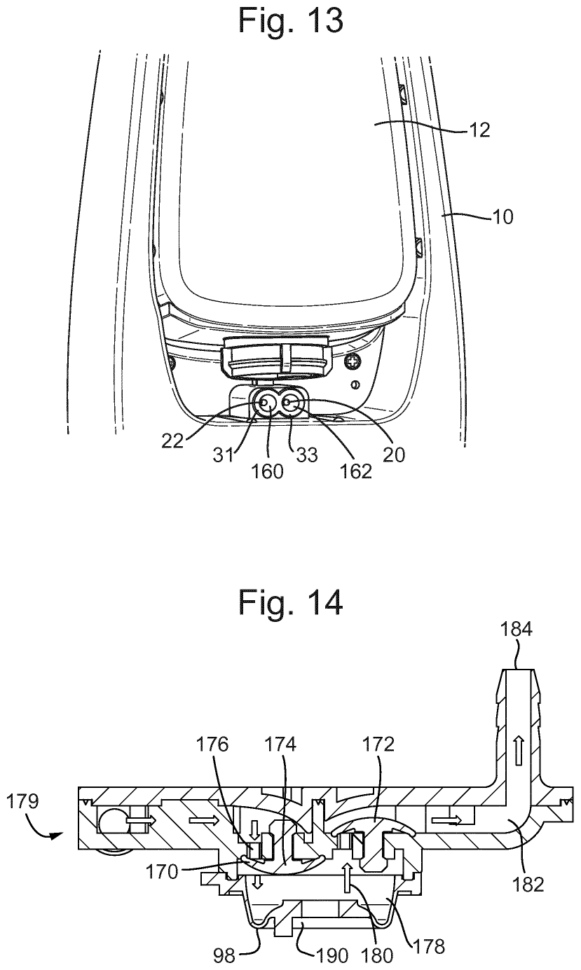

Refill cartridge 12 (FIG. 3) comprises container 26 for the washing fluid, and cap 28. Container 26 is preferably self-standing, even when empty, rather than a collapsible flexible plastic. Cartridge 12 is received snugly within space 17 (FIG. 2) of dispenser housing 10 preferably by insertion from the rear of the dispenser, shown in FIG. 5. Housing 10 includes transfer tube 22, held in place by housing 10 in the rear of block 18 (FIGS. 5, 13). In FIGS. 5 and 13, the outer end of transfer tube 22 can be see through an opening in the opposite, outer end of block 18. Transfer tube 22 (FIGS. 6 and 13) and second transfer tube 20 are generally hollow, cylindrical tubes having an open end 52 and an opposite end which terminates in a sharp point 56. Spaced from first end 52 is opening 54. The wall of tube 22 may, if desired, be beveled so that it deviates from cylindrical and would be somewhat flat.

Transfer tubes 20 and 22 terminate at point 56 at a somewhat sharper angle than the cylindrical portion of the wall. Point 56 is capable of penetrating a polymeric sealing material. Transfer tubes 20 and 22 may be needles. If desired, the transfer tubes may have more than two openings. Typically, the second ends of the transfer tubes are spaced inwardly from the opening at the outer end of the holding block 18 whereby to minimize the chance that a child could puncture the skin on the sharp end of the transfer tube. The opening of block 18 may be spaced 1-7 mm or more from point 56. Exemplary internal volume (liquid- or air-occupying volumes for the transfer tubes would be within the range of 5-30 mm³, especially from 10-20 mm³, most preferably from 12-18 mm³.

Container 26 of cartridge 12 (FIG. 8) comprises side walls 50, top wall 52, bottom wall 54, and neck 57 having external circular flange 58 and beveled lugs 59. Container 26 may be made of a thermoplastic material such as polyethylene terephthalate (PET).

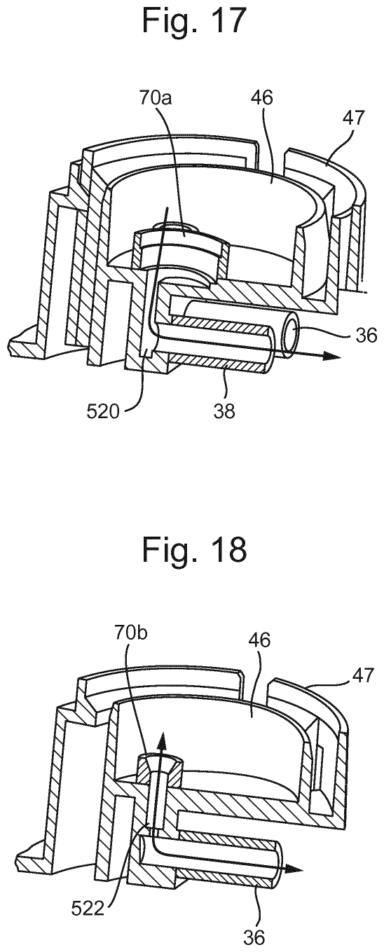

As seen in FIGS. 3, 4, and 7, cap 28 for cartridge 12 includes opposed front and rear walls 40, opposed side walls 41, bottom wall 60, crossing reinforcing ribs 42 extending upwardly from bottom wall 60, and centrally disposed locking cylinder 46 having cylindrical wall 49 and which is surrounded by outer ring 47. Outer ring 47 includes periodic interruptions or breaks 75. The interior of locking cylinder 46 is in fluid communication via openings 70a and 70b in locking cylinder floor 80 and conduits 520, 522 with hollow cylindrical walls 36, 38 (FIGS. 4, 17 and 18) accommodated within cap recess 30 formed in bottom wall 60 and front wall 40. These walls 36, 38 define apertures which will in use each be filled at its outer end with a silicone rubber seal to produce sealed walls 32, 34 (FIG. 3). The walls may be covered with a plastic material such as a clear or white plastic. The aperture-defining walls 36, 38 may be integral with conduits 520, 522, the cartridge cap, the cartridge container and/or the dispenser housing. Conduit 520 may include a generally cylindrical or other shaped passage. Conduit 522 may be funnel-shaped adjacent opening 70b, cylindrical therebelow, and lead to a narrower diameter cylindrical opening into the interior of wall 36.

Cap 28 may be made of a thermoplastic material such as polypropylene, which may be Aramco PP CP55N polypropylene (Saudi Aramco Trading Products, PO Box 5000, Dhahran, Kingdom of Saudi Arabia).

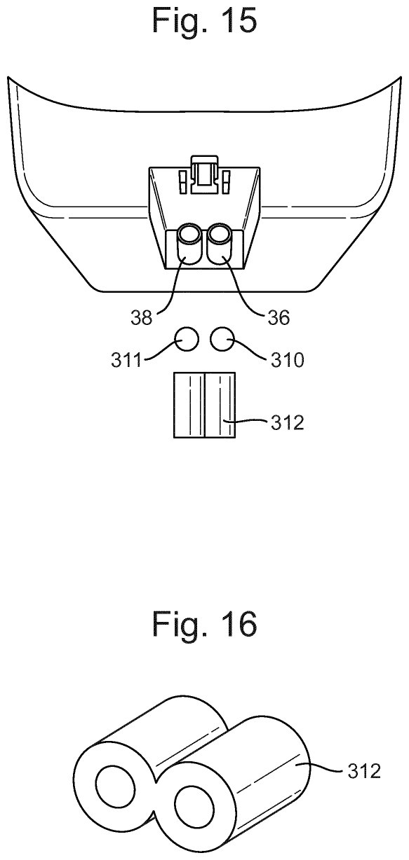

As seen in FIG. 15, silicone discs 311 and 310 are used to seal the outer ends of apertures 210, 212 in walls 38, 36. These are held in place at the mouth of walls 38, 36 using plastic cover 312, also seen in FIG. 16.

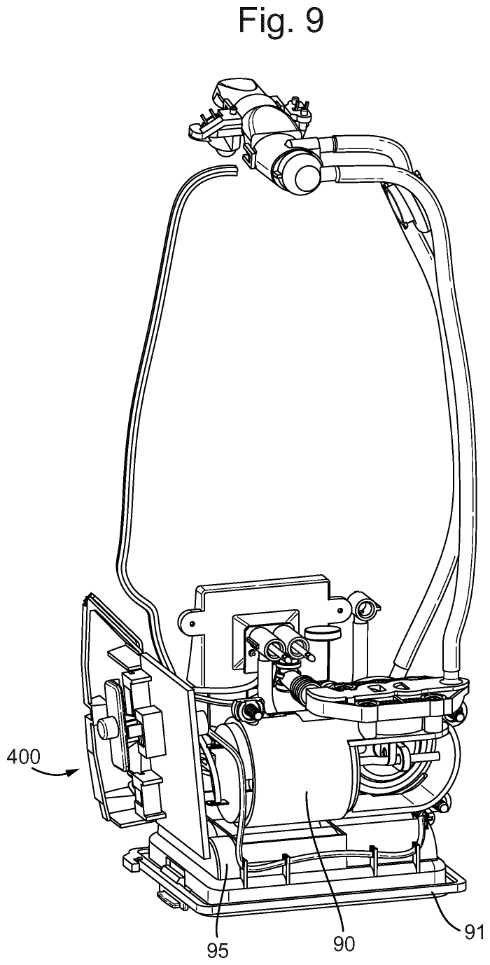

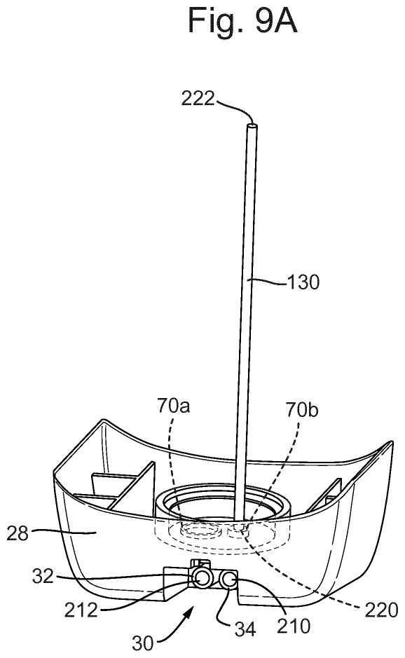

One of the passages/apertures 212 (FIG. 3) defined by the sealed cylindrical walls 32, 34 may be utilized for exiting liquid, and the other 210 is intended for air in-venting and out-venting, and leads on its (inner) cartridge end to a long, hollow, cylindrical stem 130 (FIGS. 3 and 9) within the cartridge container, which acts as a conduit in a venting system that allows air and vapor to enter and exit the cartridge. Stem 130 is rigid. Container 26 of reservoir or cartridge 12 has a bottom end 180, excluding neck 57, (FIGS. 3, 8) and a top end 182, and a height H extending from the bottom end to the top end (FIG. 3). As best seen in FIG. 9A, stem 130 preferably extends from a first stem end 220 to a second stem end 222, which second stem end is situated in the upper third of the height H of the reservoir and which stem has an air-permeable opening into the interior of the reservoir at the second end. Preferably the second end of the stem is in the upper 1/10 of the height of the reservoir. The second end of the stem or conduit is proximate the upper end of the reservoir so that it is normally in fluid communication with air in the headspace above the uppermost liquid level of the reservoir.

As an alternative to the stem, the vent opening may be in fluid communication with the headspace of the cartridge via a flexible tube that floats within the refill, or which is attached to a floating component, such that its breathing or vent opening at its end 222 is always exposed to the column of air in the refill, e.g., at the surface of the fluid.

Still further possible venting systems comprise (1) an “active” venting mechanism, where air is diverted from the air line into the venting tube. Each time a dispense is triggered, an amount of air that restores equilibrium in reservoir is diverted to the refill, keeping the refill at ideal pressure and (2) a response venting mechanism. For this, ideally, a pressure sensor senses the pressure in the refill. The device through an appropriate network of valves can also help to facilitate the process for in-venting our out-venting or both.

On the inside of the cap 28, is a mesh (not shown), which filters the soap liquid exiting the refill through the liquid channel.

The dispenser end of hollow transfer tube 22, which is located within cylindrical chamber 31, is in fluid communication through tube 140 (FIG. 12) which connects with small vent opening 150 in bulkhead 168 (FIG. 5). The vent opening can be anywhere along the surface of the front and back housing.

When refill cartridge 12 is inserted into opening 17 from the back of the dispenser, the forward end sections of cylindrical walls 32 and 34 (FIG. 4) about the forward ends 160, 162 of walls of chambers 31, 33 leaving enough space between the bulkhead 168 and the forward end of cartridge cap 28 to permit air to vent from vent opening 150. Tube 140 can be u-shaped as illustrated in FIG. 12, to prevent leakage in the event of a backup of washing fluid from the cartridge, or any other appropriate shape. In the preferred embodiment illustrated, venting occurs without any action from the printed circuit board or any other electronic control unit.

The venting arrangement of the invention permits air to vent either into or from the cartridge, as need be. For instance, as washing liquid is evacuated from the cartridge container, the vent permits air to enter the cartridge container through vent opening 150, tube 140, hollow transfer tube 22, passage/aperture 210, conduit 522 and stem 130, thus avoiding creation of a vacuum in the cartridge container. On the other hand, when the dispenser is exposed to elevated temperatures, to avoid undue pressure build-up (positive pressure) in the cartridge container, including the headspace above the washing liquid in the cartridge container, air can vent out of the cartridge container through stem 130, conduit 522, passage/aperture 210, hollow transfer tube 22, tube 140 and out vent opening 150. A build-up of pressure which is too high can force liquid through the liquid chamber, and through the nozzle if there is no venting mechanism. The absence of venting can also create a negative pressure in the refill cartridge, which can reduce the ability of a pump to effectively suck liquid from the refill.

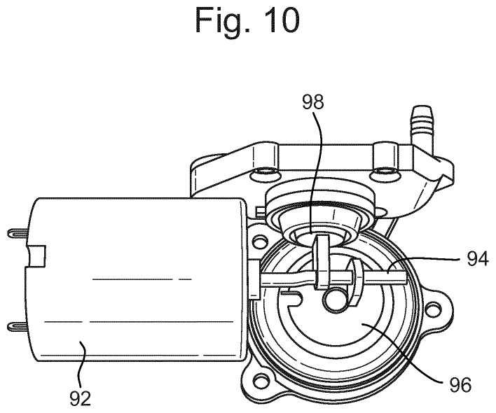

As seen particularly in FIG. 9, the housing includes a base 91 supporting a battery compartment 95. Pump assembly 90 is supported by screws (not shown) screwed into the housing body 412. Pump assembly 90 includes motor housing 92 (FIG. 10), a bent shaft 94, an LSR (liquid silicone rubber) diaphragm for air 96, an LSR diaphragm for liquid 98 (FIGS. 10 and 14), fluid intake 176 and out flow 180, umbrella valves (UV valves) 170, 172 for the liquid side and an intake flapper valve and out flow UV valve (not shown) for the air side. A pump housing holds the assembly together. A motor is contained within motor housing 92.

The washing liquid comprises water, preferably at least 40 wt %. It may additionally including other skin treatment components such as soap, synthetic detergents, moisturizers, conditioners, etc.

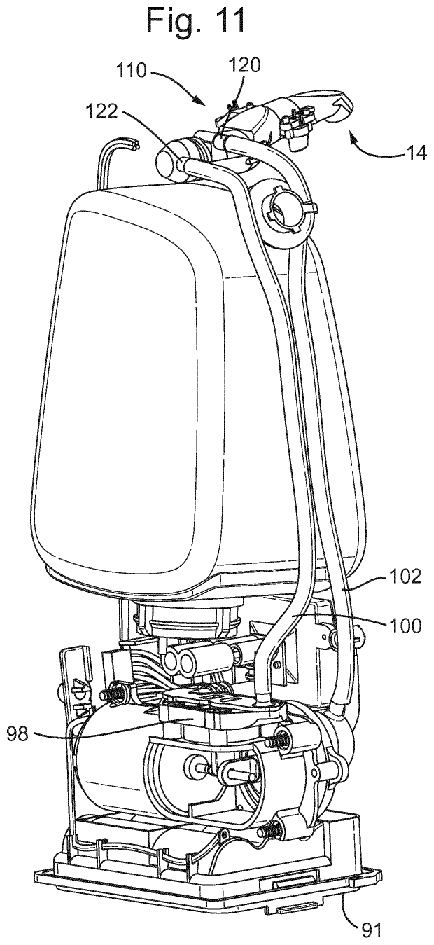

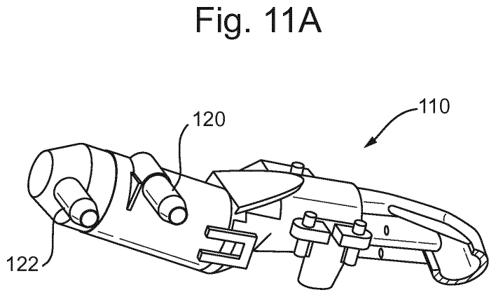

In can be seen especially in FIG. 11 that tube 100 extends upward from liquid diaphragm pump 98 to mixing chamber 110. The liquid enters the mixing chamber at liquid inlet 122 (FIGS. 11, 11A). The tubes or other conduits for the liquid and for the air may be made of silicone or other suitable materials, as will be apparent to one of ordinary skill.

Tube 102 extends upward to mixing chamber 110 from air diaphragm pump 96. Air inlet 120 is provided for entry of air into the mixing chamber. The mixing chamber includes two meshes and other structure to direct flow of the air/liquid mixture and form foam. A dispensing nozzle 14 is present at the dispensing end of the mixing chamber.

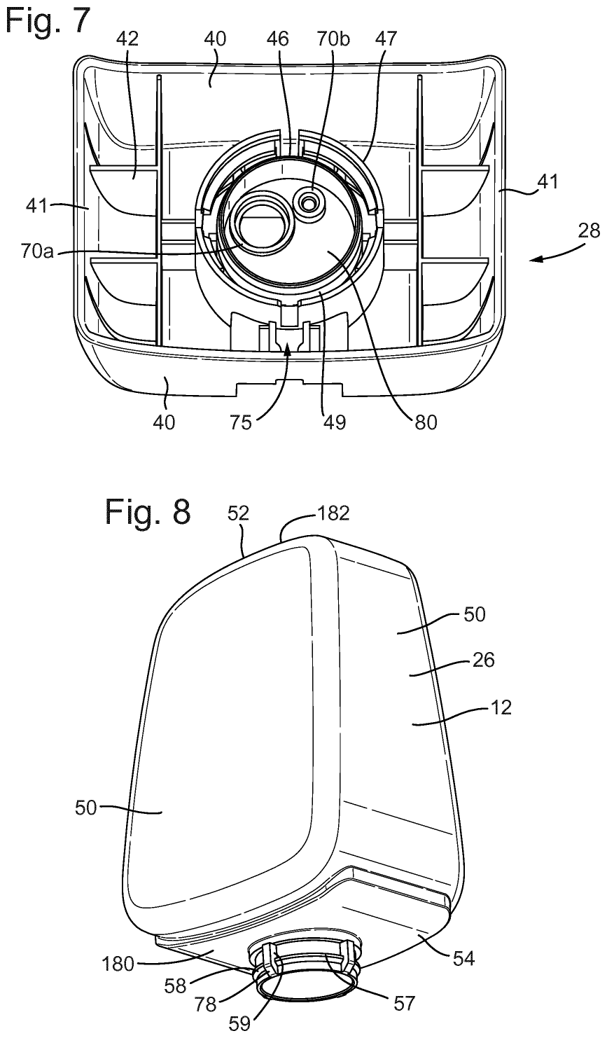

To assemble the refill cartridge, container 26 is joined to cap 28 (see FIGS. 7 and 8) by inserting container neck 57 into the cap. The neck is accommodated between cylindrical wall 49 and outer ring 47. Beveled surfaces 78 of lugs 59 on the neck guide the lugs to pass and then lock beneath outer ring 47. Cartridge 12 is inserted snugly within opening 17 in housing 10, as described in WO2016050930, the disclosure of which is hereby incorporated by reference.

When the refill assembly is inserted into the housing unit, the two transfer tubes 20, 22 which protrude from the dispenser penetrate or pierce the Liquid silicone rubber (LSR) seal in the cylindrical entry points in the cap (38, 36). One of the transfer tubes permits liquid to exit from the cartridge to the interior of the dispenser housing and the other permits air within the cartridge to in-vent and out-vent.

To activate the unit, the user places his/her hands in the activation area below the nozzle 14 (FIG. 1). The infrared light from the emitter bounces off the hands and is detected by the receiver, which then sends a signal to a printed circuit board 400 located in the housing above the battery compartment (FIG. 9) that the pump system should be activated.

After receiving a signal, the motor shaft rotates and the liquid and air side diaphragms engage in a sweeping/cyclic motion which captures a volume of air/liquid on each stroke/cycle, allowing air and liquid to pump up to the mixing chamber. The unidirectional flow of both fluids is ensured by one way umbrella and flapper valves.

In accordance with one aspect of the invention, the liquid pump includes two umbrella valves, both the intake valve 170 and the outlet valve 172 (FIG. 14). As diaphragm 98 is drawn away from valve 170 by the action of motor 92 on connecting rod or shaft 94, the pressure of liquid which is drawn into the inlet 179 impinging on head 174 of valve 170 through opening 176 forces valve 170 open and permits the liquid to enter pumping chamber 178. At this point, valve 172 is closed, thereby preventing liquid from exiting pumping chamber 178. As diaphragm 98 is forced toward valve 172 by the action of motor 92 on connecting rod or shaft 94, valve 170 is closed and valve 172 is forced open whereby liquid is pushed by action of diaphragm 98 through opening 180, through passage 182 and out pump outlet 184 to tube or conduit 100. Use of the double valve pump of the invention helps assure that liquid flows cleanly through the liquid pump by minimizing backflow to the reservoir. The umbrella valves on the liquid pump are believed to favorably influence output pressure and flow profile.

In the diaphragm pump system described, the arrangement and use of these multiple valves can help with the efficiency of the pump system. Opening and closing of the valves allows fluid to flow in one direction, by preventing backflow into the reservoir. The arrangement minimizes backflow when drawing washing liquid from the reservoir (cartridge) and pushing the liquid through to the mixing chamber. It also allows enough pressure build up in the pump chamber to propel the fluid to the mixing chamber. Each of the valves has a certain crack pressure (opening pressure) and leak pressure which can readily be determined by one of ordinary skill. If desired, expansion and contraction of the pumping chamber could be interchanged by exchanging the opening and closing of the first and second valve.

Washing liquid is pumped up to mixing chamber 110 through tube 100 which liquid travels upward from liquid diaphragm pump 98. Air is pumped up to mixing chamber 110 through tube 102 which travels upward from air diaphragm pump 96. The liquid enters the mixing chamber at the liquid inlet 122 and air enters at the air inlet 120. The liquid and air are then forced into the mixing chamber through a fixture containing smaller holes. The mixture is forced through two meshes where they are mixed. The final product is a rich foam which is ejected through nozzle 14.

Connecting rod or shaft 94 may be made of an acetal co-polymer such as Formosacon® FM090 available from Formosa Polychem Corporation of Chung Yang Industrial Park, Hsin Kang, Chia Yi County, Taiwan.

The pumps preferably comprise ABS, such as Polylac PA-757 ABS available from Chi Mei Corporation of Taiwan, No. 59-1, Sanjia, Rende Dist., Tainan City 71702, Taiwan.

Housing 10 of dispenser 11 may be made of polypropylene, especially Formosa polypropylene 3204 available from Yungsox of NO. 1, SHIHHUA 1ST RD., LINYUAN DISTRICT, KAOHSIUNG CITY 832, TAIWAN.

Transfer penetrating tubes 20, 22, may be fabricated from stainless steel, available from Wenzhou Kelon Metal Manufacturing Co. Ltd., No 458 Jianzhong, Yonzhong Street, Lonwan District, Wenzhou, Zhenjiang, China.

The meshes may be the same or different and may be made of known materials such as nylon.

Although it is preferred that the top and side walls of the cartridge container 26 are continuous and do not contain any openings, it is possible that an opening may be created puncturing the top and/or side walls with a penetrating object such as a drill, a corkscrew, a knife or other penetrating object, and re-filling the cartridge by pouring fluid, e.g., washing fluid, through the opening. If made, this opening is preferably made in the top wall and/or a portion of the side walls in the upper half of the height of the cartridge, the height being measured from the lowest part of the bottom wall to the highest part of the top wall. The opening can then be closed, e.g., with a mechanical or chemical sealant, after the cartridge has been filled to the extent desired. For example, the opening can subsequently be closed by using a rubber plug or stopper or a sticky duct tape or some such closure mechanism.

Accordingly, the invention is also directed to a method of refilling a cartridge having a bottom wall, a top wall and side walls between the bottom and the top wall, the cartridge having a height extending from a lowest part of the bottom wall (excluding the neck) to an uppermost part of a top wall, the bottom, top and side walls of the refill cartridge defining a container for containing a fluid, the cartridge including at least one of
i) one or more walls defining an aperture sealed with a polymeric seal, the aperture being large enough to accommodate a transfer tube, the aperture being in communication directly or indirectly with the fluid or
ii) a hollow tube having at least two openings, the hollow tube extending directly or indirectly from the cartridge, one opening being in communication directly or indirectly with the fluid in the cartridge and the second opening in fluid communication with the exterior of the cartridge,
the method comprising puncturing a wall selected from the group of a) the top wall and b) one or more side walls, in the upper 50% of the height of the cartridge, and c) combinations thereof, to create an opening through which fluid can be introduced.

The method of the invention further comprises introducing fluid, e.g., washing fluid, into the opening.

It will be appreciated that although reference is made to soap containers/cartridges, other washing fluids can be used including fluids having ingredients such as mild cleansing creams as well as antibacterial and/or moisturizing properties.

The invention includes the following numbered aspects:
1. A connecting system comprising:
   a) a hollow transfer tube having at least two openings and
   b) one or more walls defining an aperture sealed at one end with a polymeric seal, the aperture being large enough to accommodate the tube.
2. The system according to claim 1 wherein the aperture is cylindrical.
3. The system according to claim 1 wherein the polymeric seal comprises an elastomer.
4. The system according to claim 1 wherein the polymeric seal comprises a thermoset elastomer.
5. The system according to claim 1 wherein the polymeric seal comprises liquid silicone rubber.
6. The system according to claim 1 wherein the transfer tube comprises a hollow wall having a first opening at a first end, the transfer tube terminating at a penetrating point at a second end and the transfer tube extending 360° around a central axis and the transfer tube further comprising a second opening spaced from the first opening.
7. The system according to claim 6 wherein the tube wall comprises two approximately 180° sides and the second opening is contained within one of said sides.
8. The system according to claim 6 wherein the tube wall comprises a rounded side extending approximately 180° around the central axis and a second side including the second opening, the second side including a flat wall, the second opening being received within the flat wall.
9. The connecting system according to claim 1 wherein the seal is re-sealable.
10. A connector suitable for receiving a transfer tube, the connector comprising one or more walls defining an aperture, the aperture being sealed at one end with a polymeric seal and the aperture being large enough to accommodate the transfer tube.
11. The connector according to claim 10 wherein the aperture is cylindrical.
12. The connector according to claim 10 wherein the polymeric seal comprises an elastomer.
13. The connector according to claim 10 wherein the polymeric seal comprises a thermoset elastomer.
14. The connector according to claim 10 wherein the polymeric seal comprises liquid silicone rubber.
15. The system according to claim 1 wherein said one or more walls of the aperture are integral with the housing or a cap of a dispenser or a dispenser refill cartridge.
16. The connector according to claim 10 wherein the one or more walls of the aperture are integral with the housing or a cap of a dispenser or a dispenser refill cartridge.
17. A dispenser comprising a housing having an opening suitable for accommodating a refill cartridge, said housing having at least one of
   i) one or more walls defining an aperture sealed at one end with a polymeric seal, the aperture being large enough to accommodate a transfer tube, the aperture being in fluid communication with a conduit within the housing or
   ii) a hollow transfer tube having at least two openings extending from the housing, one opening being in communication with a conduit in the housing and the second opening in fluid communication with the exterior of the dispenser housing.
18. A refill cartridge comprising a container for containing a fluid and at least one of
   i) one or more walls defining an aperture sealed at one end with a polymeric seal, the aperture being large enough to accommodate a transfer tube, the aperture being in communication directly or indirectly with the fluid or
   ii) a hollow transfer tube having at least two openings, the hollow tube extending from the cartridge, one opening being in communication directly or indirectly with the fluid in the cartridge and the second opening in fluid communication with the exterior of the cartridge.
19. The connector according to claim 10 wherein the polymeric seal is re-sealable.
20. The dispenser according to claim 17 wherein the polymeric seal is re-sealable.
21. The refill cartridge according to claim 18 wherein the polymeric seal is re-sealable.
22. The connecting system of claim 1 comprising at least two transfer tubes.
23. The dispenser according to claim 17 comprising at least two hollow transfer tubes extending from the housing.
24. A pump comprising a first umbrella valve, a pumping chamber downstream of the first valve, and a second umbrella valve downstream of the pumping chamber, the pumping chamber being adapted to expand and contract, the first valve opening and the second valve closing as the pumping chamber expands and the first valve closing and the second valve opening as the pumping chamber contracts.
25. The pump according to claim 24 wherein the pumping chamber comprises at least in part a flexible diaphragm.
26. The connecting system according to claim 1 wherein the hollow transfer tube comprises more than two openings.
27. Method of refilling a cartridge having a bottom wall, a top wall and side walls between the bottom and the top wall, the cartridge having a height extending from a lowest part of the bottom wall excluding any neck to an uppermost part of a top wall, the bottom, top and side walls of the refill cartridge defining a container for containing a fluid, the cartridge including at least one of
   iii) one or more walls defining an aperture sealed at one end with a polymeric seal, the aperture being large enough to accommodate a transfer tube, the aperture being in communication directly or indirectly with the fluid or
   iv) a hollow tube having at least two openings, the hollow tube extending directly or indirectly from the cartridge, one opening being in communication directly or indirectly with the fluid in the cartridge and the second opening in fluid communication with the exterior of the cartridge,
   the method comprising puncturing a wall selected from the group of a) the top wall and b) one or more side walls, in the upper 50% of the height of the cartridge, and c) combinations thereof, to create an opening through which fluid can be introduced.
28. The method of claim 27 further comprising introducing fluid into the opening.
29. A combined dispenser and refill cartridge comprising a dispenser comprising a housing having an opening suitable for accommodating a refill cartridge and having a dispensing aperture, said housing having a hollow transfer tube having at least two openings extending from the housing, one opening being in communication with a conduit in the housing leading directly or indirectly to the dispensing aperture and the second opening in fluid communication with the exterior of the dispenser housing, a refill cartridge received within the dispenser opening and comprising a container for containing a fluid and one or more walls defining an aperture sealed at one end with a polymeric seal, the aperture receiving the transfer tube, the aperture being in communication directly or indirectly with the fluid contained within the container of the cartridge.
30. The combined dispenser and refill cartridge according to claim 29 wherein the refill cartridge comprises the container and a cap attached thereto, the aperture walls being in the cap.

It should be understood, of course, that the specific forms of the invention herein illustrated and described are intended to be representative only as certain changes may be made therein without departing from the clear teachings of the disclosure. Accordingly, reference should be made to the following appended claims in determining the full scope of the invention.

1. A dispenser (11) comprising a dispenser housing (10) having an opening suitable for accommodating a refill cartridge and having a dispensing aperture (14), a refill cartridge (12) in the refill cartridge opening (17), the refill cartridge comprising a container for containing a fluid, the improvement wherein the dispenser includes:
a) hollow transfer tubes (20) (22) each having at least two openings extending from the dispenser housing and terminating in a sharp point at a second end, one of said transfer tube openings being in communication with a conduit in the housing leading directly or indirectly to the dispensing aperture (14) and
b) the cartridge including cylindrical (36), (38) walls defining apertures sealed at one end with a polymeric seal, one cartridge aperture being large enough to accommodate the transfer tube (20), the cartridge aperture receiving the transfer tube, one cartridge aperture being in communication directly or indirectly with the fluid contained within the container of the cartridge (12), the transfer tubes (20), (22), being contained in a holding block (18) in the dispenser housing (10) and one of the transfer tubes permitting air to vent through a venting tube 140 and out vent opening 150, the second ends of the transfer tubes being spaced inwardly from the opening at the outer end of the holding block (18).

2. (canceled)

3. The dispenser according to claim 1 wherein the polymeric seal comprises an elastomer.

4. The dispenser according to claim 1 wherein the polymeric seal comprises a thermoset elastomer.

5. The dispenser according to claim 1 wherein the polymeric seal comprises liquid silicone rubber.

6. The dispenser according to claim 1 wherein the transfer tube (20) comprises a hollow wall having a first opening at a first end, the transfer tube terminating at a penetrating point at a second end and the transfer tube extending 360° around a central axis and the transfer tube further comprising a second opening spaced from the first opening.

7. The dispenser according to claim 5 wherein the transfer tube wall comprises two approximately 180° sides and the second opening is contained within one of said sides.

8. The dispenser according to claim 5 wherein the transfer tube wall comprises a rounded side extending approximately 180° around the central axis and a second side including the second opening, the second side including a flat wall, the second opening being received within the flat wall.

9. The dispenser according to claim 1 wherein the seal is re-sealable.

10. (canceled)

11. (canceled)

12. (canceled)

13. (canceled)

14. (canceled)

15. (canceled)

16. (canceled)

17. The dispenser according to claim 1 wherein the polymeric seal is formed from silicone discs.

18. The dispenser according to claim 1 wherein the first and second transfer tubes penetrate the seals in the first and second cylindrical walls whereby one of the transfer tubes permits liquid to exit the cartridge and the other permits air within the cartridge to vent.

19. The dispenser according to claim 10 wherein the venting transfer tube permits air to in-vent and out-vent.

20. The dispenser according to claim 1 wherein the transfer tubes are needles.
